(19) United States
(12) Patent Application Publication
(10) Pub. No.: US 2015/0109191 A1
(43) Pub. Date: Apr. 23, 2015

(54) Speech Recognition

(71) Applicants: Michael Patrick Johnson, Sunnyvale, CA (US); Hayes Solos Raffle, Palo Alto, CA (US)

(72) Inventors: Michael Patrick Johnson, Sunnyvale, CA (US); Hayes Solos Raffle, Palo Alto, CA (US)

(73) Assignee: GOOGLE INC., Mountain View, CA (US)

(21) Appl. No.: 13/398,148

(22) Filed: Feb. 16, 2012

(51) Int. Cl. G09G 5/00; G06F 3/01; G10L 17/22; G02B 27/01

(52) U.S. Cl. CPC G06F 3/013; G10L 17/22; G02B 27/017; G02B 2027/0178
USPC 345/156

(57) ABSTRACT

Example methods and systems activate and deactivate a voice interface based on gaze directions. A computing device can define a range of voice-activation gaze directions and, in some cases, define a range of social-cue gaze directions, where the range of social-cue gaze directions overlaps the range of voice-activation gaze directions. The computing device can determine a gaze direction. The computing device determines whether the gaze direction is within the range of voice-activation gaze directions. In response to determining that the gaze direction is within the range of social-cue directions, the computing device can activate a voice interface. In response to determining that the gaze direction is not within the range of social-cue directions, the computing device can deactivate the voice interface.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and/or less obtrusive.

The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a very small image display element close enough to a wearer's (or user's) eye(s) such that the displayed image fills or nearly fills the field of view, and appears as a normal sized image, such as might be displayed on a traditional image display device. The relevant technology may be referred to as “near-eye displays.” In some configurations, wearable computers can receive inputs from input devices, such as keyboards, computer mice, touch pads, and buttons. In other configurations, wearable computers can accept speech inputs as well or instead via voice interfaces.

Emerging and anticipated uses of wearable displays include applications in which users interact in real time with an augmented or virtual reality. Such applications can be mission-critical or safety-critical, such as in a public safety or aviation setting. The applications can also be recreational, such as interactive gaming.

### SUMMARY

In one aspect, an example method can include: (a) defining a range of voice-activation gaze directions using a computing device, (b) determining a gaze direction using the computing device, (c) determining whether the gaze direction is within the range of voice-activation gaze directions using the computing device, and (d) in response to determining that the gaze direction is within the range of voice-activation gaze directions, activating a voice interface of the computing device.

In another aspect, an example computing device can include a processor, a voice interface, a non-transitory computer-readable medium and program instructions stored on the non-transitory computer-readable medium. The program instructions are executable by the processor to cause the wearable computing device to perform functions. The functions can include: (a) defining a range of gaze directions, wherein each gaze direction in the range of gaze directions is capable of triggering activation of the voice interface (b) determining a gaze direction, (c) determining whether the gaze direction is within the range of gaze directions, and (d) in response to determining that the gaze direction is within the range of gaze directions, activating the voice interface.

In yet another aspect, an article of manufacture can include a non-transitory computer-readable medium having instructions stored thereon that, when executed by a computing device, cause the computing device to perform functions. The functions can include: (a) defining a range of voice-activation gaze directions, (b) determining a gaze direction, (c) determining whether the gaze direction is within the range of voice-activation gaze directions, and (d) in response to determining that the gaze direction is within the range of voice-activation gaze directions, activating a voice interface.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a flow chart illustrating a method, according to an example embodiment.

FIGS. 2A-2D depicts an example scenario of a wearer of a wearable computing device activating and deactivating a voice interface.

FIG. 3A is a block diagram illustrating a head mountable device configured to determine gaze directions.

FIG. 3B is a cut-away diagram of an eye gazing in a gaze direction, according to an example embodiment.

FIG. 3C is a diagram of a voice interface receiving audio input from speakers and generating text output, according to an example embodiment.

FIG. 4 illustrates example scenario for switching interfaces for a mobile device based on gaze detection, according to an example embodiment.

FIG. 5 illustrates an example vehicle interior, according to an example embodiment.

FIGS. 6A and 6B illustrate a wearable computing device (WCD), according to an example embodiment.

FIG. 7 illustrates another wearable computing device, according to an example embodiment.

FIG. 8 illustrates yet another wearable computing device, according to an example embodiment.

FIG. 9 illustrates an example schematic drawing of a computer network infrastructure in which an example embodiment may be implemented.

### DETAILED DESCRIPTION

### Introduction

One problem in using a voice interface is the “voice segmentation problem”, which is a problem of determining when to activate and deactivate the voice interface. The voice segmentation problem involves segmenting speech (or other audio information) into a portion of speech which is directed to a speech recognition system of the voice interface and a portion of speech that is directed to other people. A desired solution to the voice segmentation problem would enable both easy switching between speaking to the speech recognition system and speaking to human conversation partners and clearly indicating to whom each speech action is directed.

One approach to address the voice segmentation problem is to use gaze detection to activate or deactivate a voice interface. In particular, a gaze can be detected in a range of “voice-activation gaze directions”, where a voice-activation gaze direction is a gaze direction capable of triggering activation, deactivation, or toggling of an activation state of a voice interface. In the context of wearable computers with heads-up displays, when a wearer is gazing straight ahead, such as when looking directly at a conversational partner, the system can recognize that that the wearer's gaze is not directed in a voice-activation gaze direction and so speech is not to be directed to the voice interface.

However, when the wearer's gaze is directed to one or more predefined portions of the heads-up display, such as a portion positioned slightly upward from a typical gaze, then the system can recognize that the wearer's gaze is directed in a voice-activation gaze direction. This (slight) upward gaze can provide a social cue from the wearer to the conversational partner that the wearer is not currently involved in the conversation. By picking up the social cue, the conversational partner can recognize that any speech is not directed toward him/her, but rather directed elsewhere. Then, upon recognizing the gaze is in a voice-activation gaze direction, speech can be directed to the voice interface.

In other embodiments, gazing at an electromagnetic emissions sensor (EES) or a camera can toggle activation of the voice interface. For example, suppose a deactivated speech recognition system is equipped with a camera for detecting gazes. Then, in response to a first gaze at the camera, the speech recognition system can detect the first gaze as being in a voice-activation gaze direction and activate the speech recognition system. Later, in response to a second gaze at the camera, the speech recognition system can detect the second gaze as being in a voice-activation gaze direction and deactivate the speech recognition system. Subsequent gazes detected in voice-activation gaze directions can continue toggling an activation state (e.g., activated or deactivated) of the speech recognition system.

The concept of using gaze detection to activate speech recognition systems of voice interfaces can be expanded to other devices as well. For example, in the home, a television set could have a camera mounted out of the way of normal viewing angles. Then, when the television detected a television watcher was looking at the camera, the television could activate a speech recognition system, perhaps after muting any sound output of the television. The voice interface could be used to instruct the television set using voice commands, such as to change the channel or show a viewing guide, and then the television watcher could look away from the camera to stop using the speech recognition system. Other devices, such as, but not limited to, mobile phones, vehicles, information kiosks, personal computers, cameras, and other devices, could use gaze detection to activate/deactivate speech recognition system and voice interfaces as well.

### Example Methods

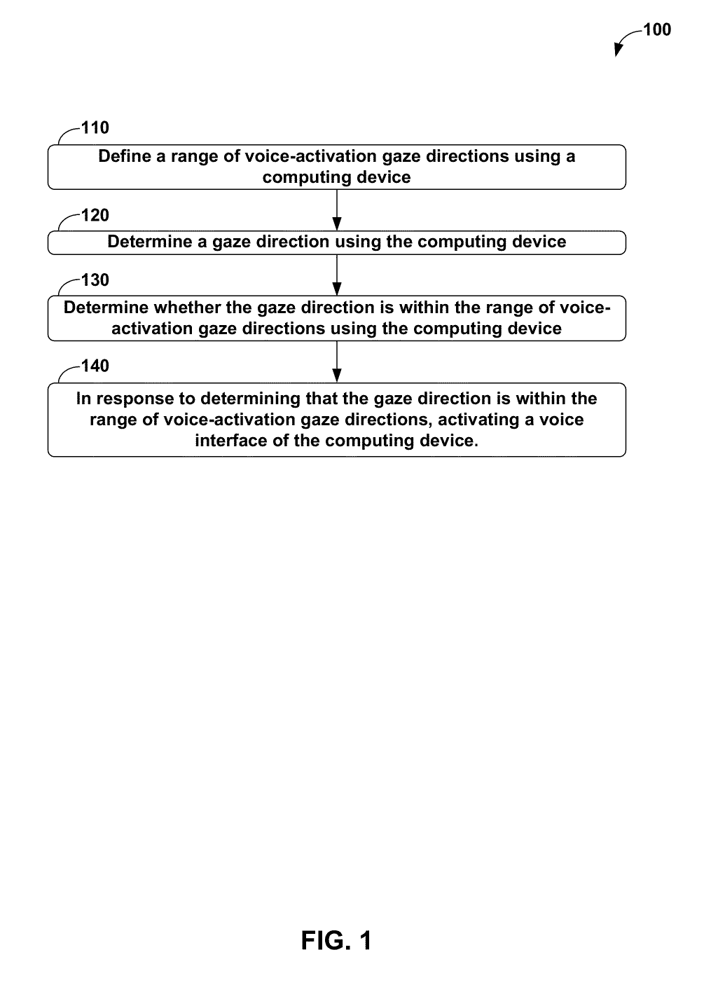

FIG. 1 is a flow chart illustrating method 100, according to an example embodiment. Method 100 can be implemented to activate a voice interface of a computing device. Method 100 is described by way of example as being carried out by a computing device, but may be carried out by other devices or systems as well. In some embodiments, the computing device can be configured as a wearable computing device, a mobile device, or some other type of device. In other embodiments, the computing device can be configured to be embedded in another device, such as a vehicle.

Method 100 begins at block 110. At block 110, a computing device can define a range of voice-activation gaze directions. In some embodiments, defining a range of voice-activation gaze directions can include defining a range of social-cue gaze directions. The range of social-cue gaze directions can overlap the range of voice-activation gaze directions. In other embodiments, defining a range of voice-activation gaze directions can include defining a range of deactivation gaze directions. The range of deactivation gaze directions can be selected not to overlap the range of voice-activation gaze directions.

At block 120, the computing device can determine a gaze direction.

At block 130, the computing device can determine whether the gaze direction is within the range of voice-activation gaze directions.

At block 140, the computing device can, in response to determining that the gaze direction is within the range of voice-activation gaze directions, activate the voice interface of the computing device.

In some embodiments, in response to determining the gaze direction, the computing device can determine whether the gaze direction is within the range of social-cue gaze directions. Then, in response to determining that the gaze direction is within the range of social-cue directions, the computing device can activate the voice interface. Alternatively, in response to determining that the gaze direction is not within the range of social-cue directions, the computing device can deactivate the voice interface.

In other embodiments, after activating the voice interface, the computing device can receive speech input via the activated voice interface. A textual interpretation of at least part of the speech input can be generated. A command can be provided to an application, such as but not limited to a software application executing on the computing device, based on the textual interpretation.

In even other embodiments, the computing device can determine whether the gaze direction remains within the range of voice-activation gaze directions. In response to determining that the gaze direction does not remain within the range of voice-activation gaze directions, the computing device can deactivate the voice interface.

In yet other embodiments, the computing device can display a voice activation indicator on a display of the computing device. Then, the range of voice-activation gaze directions can comprises a range of gaze-directions from an eye toward the voice activation indicator. In particular of these embodiments, the voice activation indicator can be configured to indicate whether or not the voice interface is activated.

In still other embodiments, the computing device is configured to maintain an activation status of the voice interface that corresponds to the activation of the voice interface. That if, the voice interface is activated, the activation status is activated, and if the voice interface is not activated, the activation status is not activated. Then, the computing device can determine whether the gaze direction remains within the range of voice-activation gaze directions. In response to determining that the gaze direction does not remain within the range of voice-activation gaze directions, the computing device can maintain the activation status of the voice interface. Then, after maintaining the activation of the voice interface, the computing device can determine whether a later gaze direction is within the range of voice-activation gaze directions. In response to determining that the later gaze direction is within the range of voice-activation gaze directions, the computing device can toggle the activation status of the voice interface.

Example Scenario Using Gaze Detection for Voice

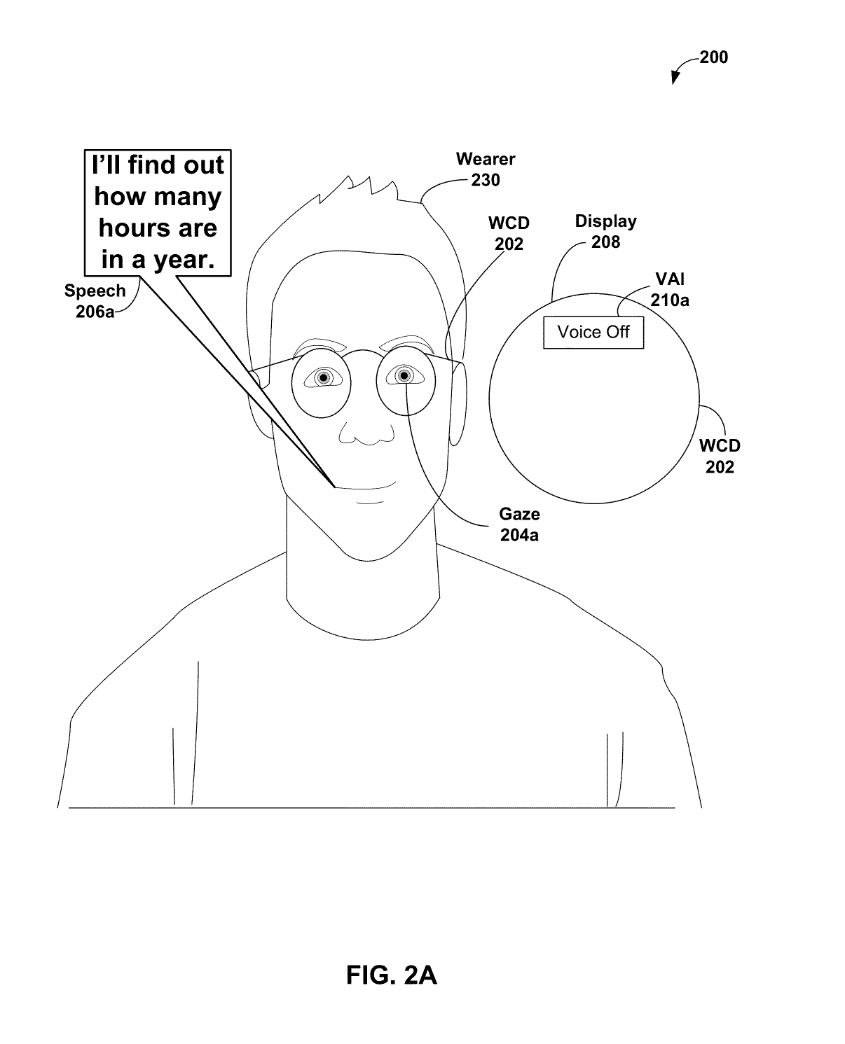

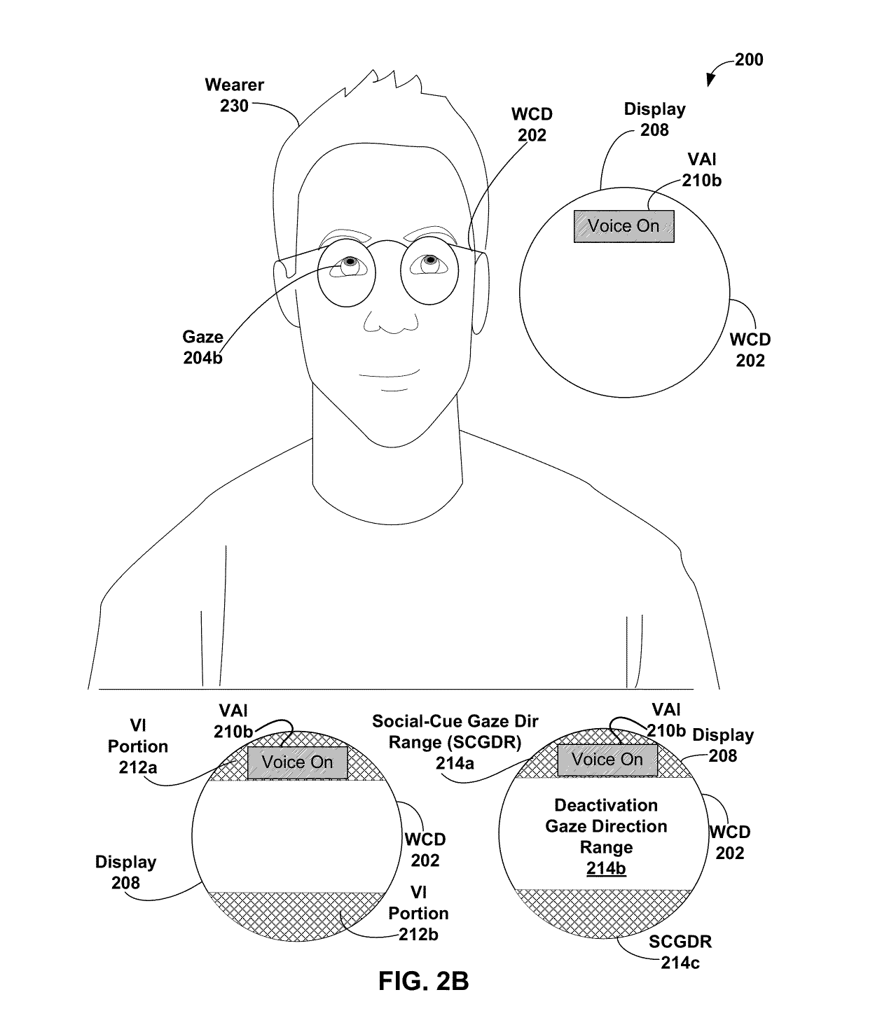

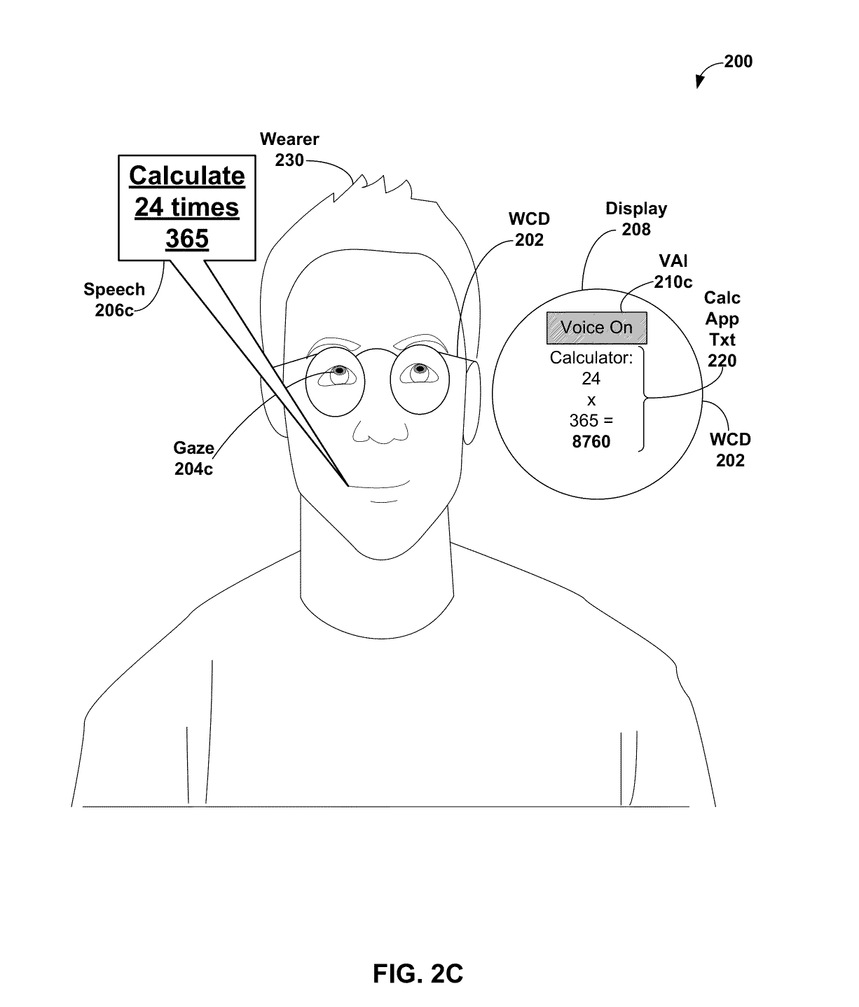

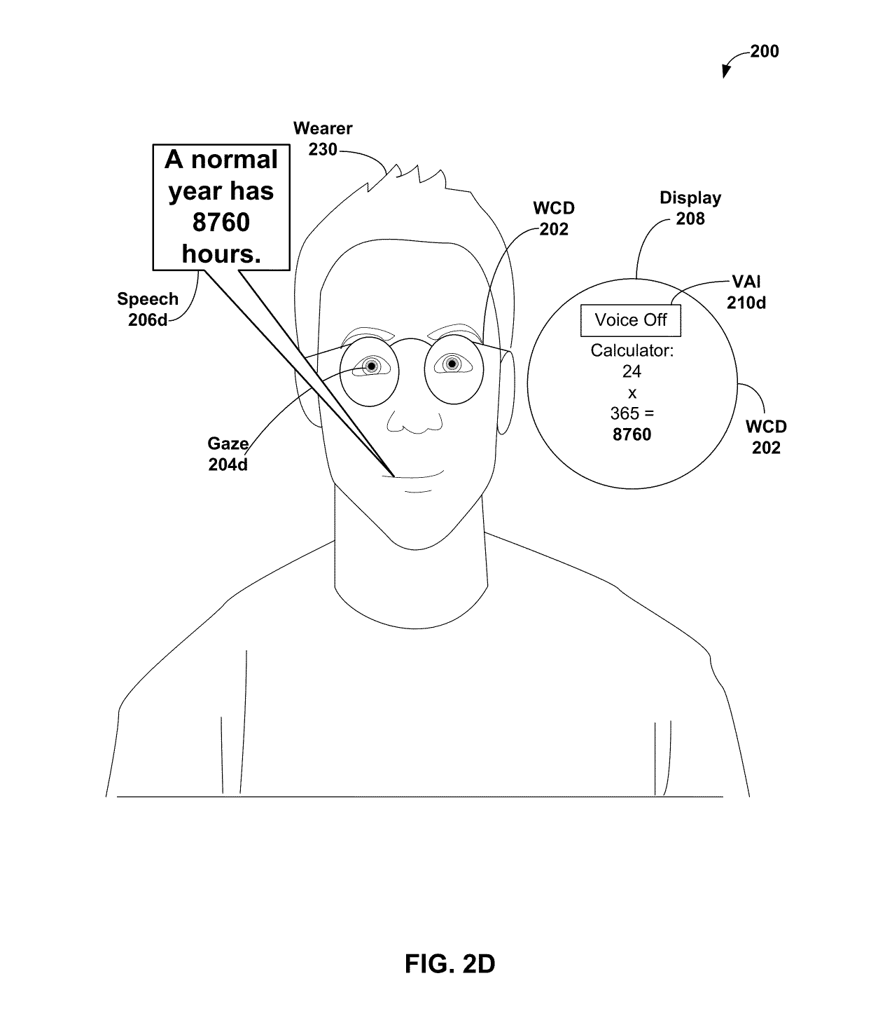

FIGS. 2A-2D show an example scenario 200 with wearer 230 of wearable computing device (WCD) 202 activating and deactivating a voice interface. Scenario 200 is shown from the point of view of a conversational partner of wearer 230 (conversational partner not shown in FIGS. 2A-2D). Turning to FIG. 2A, scenario 200 begins with wearer 230 gazing with gaze 204a at the conversational partner and uttering speech 206a of “I'll find out how many hours are in a year.” As part of scenario 200, wearable computing device 202 generates display 208 with voice activation indicator (VAI) 210a that indicates a voice interface to wearable computing device 202 is off. In some embodiments, display 208 can be configured to display textual, graphical, video, and other information in front of a left eye of wearer 230. In other embodiments, display 208 can be configured to display textual, graphical, video, and other information in front of a right eye of wearer 230. In still other embodiments, wearable computing device 202 can be configured with multiple displays; e.g., a display for a left eye of wearer 230 and a display for a right eye of wearer 230.

Scenario 200 continues, as shown in FIG. 2B, with wearer 230 gazing with gaze 204b at voice activation indicator (VAI) 210b shown in display 208 of wearable computing device 202. Wearable computing device 202 detects gaze 204b and determines that gaze 204b is directed to the portion of the display with voice activation indicator 210b. In some embodiments, wearable computing device 202 can determine that gaze 200b is directed toward voice activation indicator 210b after determining a duration of gaze 200b exceeds a threshold amount of time such as 250-500 milliseconds.

Upon determining that gaze 204b is directed at voice activation indicator 210b, wearable computing device 202 can activate its voice interface. In some embodiments, such as shown in FIG. 2B, display 208 can change voice activation indicator 210b to indicate that the voice interface is activated. The change in indication can be visual, such as changing text to “Voice On” as depicted in the upper-right portion of FIG. 2B, and/or changing size, shape, and/or color of indicator 210b. Alternatively or additionally, an indication that the voice interface can be audible, such as an indication using tones, music, and/or speech.

Generally, wearable computing device 202 can designate one or more voice-indicator (VI) portions 212a, 212b of display 208 to be associated with activating/deactivating the voice interface, as shown in the bottom-left portion of FIG. 2B. When a gaze of wearer 230 is determined to be directed at a voice-indicator portion of the voice-indicator portions 212a, 212b, wearable computing device 202 can activate the voice interface. For example, voice-indicator portion 212a contains voice activation indicator 210b; that is, when the gaze of wearer 230 is directed at voice activation indicator 210b, the gaze of wearer 230 can also be determined to be within voice-indicator portion 212a, and thus activate the voice interface. In some embodiments not shown in the Figures, a voice activation indicator can be displayed within voice-indicator portion 212b instead of or in addition to voice-indicator portion 212a.

At the bottom-right portion of FIG. 2B, display 208 is divided into three ranges: upper social-cue gaze-direction range (SCGDR) 214a, deactivation gaze-direction gaze direction range 214b, and lower social-cue gaze-direction range 214c. FIG. 2B shows that upper social-cue gaze-direction range 214a covers the same region of display 208 as voice-indicator portion 212a and lower social-cue gaze-direction range 214a covers the same region of display 208 as voice-indicator portion 212b. In other embodiments, voice activation portion(s) of display 208 can cover different regions than social-cue gaze-direction ranges. In still other embodiments, more or fewer social-cue gaze-direction ranges and/or voice indicator portions can be used in display 208. In even other embodiments, display 208 can have more than one deactivation gaze-direction gaze direction range.

When a gaze of wearer 230 is determined to be within a social-cue gaze-direction range 214a or 214b, wearable computing device 202 can activate the voice interface. For example, social-cue gaze-direction range 214a contains voice activation indicator 210b; that is, when the gaze of wearer 230 is at voice activation indicator 210b the gaze of wearer 230 can also be determined to be within social-cue gaze-direction range 214a, and thus activate the voice interface. In some embodiments not shown in the Figures, a voice activation indicator can be displayed within social-cue gaze-direction range 214b instead of or as well as voice activation indicator 210b displayed within social-cue gaze-direction range 214a.

In embodiments not shown in the Figures, the voice interface can be activated in response to both the gaze of wearer 230 being within a social-cue gaze-direction range 214a, 214b and at least one secondary signal. The secondary signal can be generated by wearer 230, such as a blink, an additional gaze, one or more spoken words (e.g., “activate speech interface”), pressing buttons, keys, etc. on a touch-based user interface, and/or by other techniques.

Also or instead, a secondary signal can be generated by wearable computing device 202. For example, if wearable computing device 202 determines that the gaze of wearer 230 is within a social-cue gaze-direction range 214a, 214b longer than a threshold period of time, such as 1-3 seconds, then wearable computing device 202 can generate the secondary signal. In some embodiments, the secondary signal can be generated before the gaze of wearer 230 is detected within a social-cue gaze detection range 214a, 21b. In other embodiments, use of the secondary signal in partially activating and/or confirming activation of the voice interface can be enabled and/or disabled, perhaps by wearer 230 interacting with an appropriate user interface of wearable computing device 202. In still other embodiments, multiple secondary signals can be required to confirm activation of the voice interface. Many other possibilities for generating and using secondary signals to partially activate and/or confirm activation of voice interfaces are possible as well.

If an eye of wearer 230 gazes through either social-cue gaze-direction range 214a or range 214b of display 208, then the conversational partner of wearer 230 can infer wearer 230 is not talking to the conversational partner. The conversational partner can make this inference via a social cue, since wearer 230 is not looking directly at the conversational partner. For example, when the eyes of wearer 230 gaze with gaze 204 in a gaze direction within social-cue gaze-direction range 214a, such as shown in FIG. 2B, gaze 204b is looking in a direction above the head of the conversational partner. Similarly, when the eye of wearer 230 gazes in a gaze direction within social-cue gaze-direction range 214b, the eye of wearer 230 is looking in a direction at the feet of the conversational partner. In either case, the conversational partner can infer that wearer 230 is not talking to the conversational partner, since wearer 230 is not looking directly at the conversational partner.

Turning to FIG. 2C, once the voice interface is active in scenario 200, wearer 230 can utter speech 206c directed to wearable computing device 202. A microphone or similar device of wearable computing device 202 can capture speech 206c, shown in FIG. 2C as “Calculate 24 times 365”, and a speech recognition system of the voice interface can process speech 206c as a voice command. In some embodiments, the speech recognition system can provide a textual interpretation of speech 206c, and provide part or all of the textual interpretation to an application, perhaps as a voice command.

In scenario 200, the first word “calculate” of speech 206c can be interpretation as a request for a calculator application. Based on this request, the speech recognition system can direct subsequently generated textual interpretations to the calculator application. For example, upon generating the textual interpretation of the remainder of speech 206c of “24 times 365,” the speech recognition system can then provide text of “24 times 365” to the calculator application.

The calculator application can generate calculator application text 220 indicating that the calculator application was activated with the output “Calculator”, output text and/or symbols confirming the reception of the words “24”, “times”, and “365” to text, and consequently output a calculated result of 8,760. Upon generating part or all of the output text and/or the calculated result, the calculator application can provide the output text and/or the calculated result to wearable computing device 202 for display. In other examples, other applications, output modes (video, audio, etc.), and/or calculations can be performed and/or used.

FIG. 2C also shows that, throughout utterance of speech 206c, the wearer continues to gaze with gaze 204c at voice activation indicator 210c. In some embodiments, wearable computing device 202 can continue to utilize the voice interface only while gaze 204c is directed at voice activation indicator 210c. In other embodiments, wearable computing device 202 can continue to utilize the voice interface only while speech is being received (perhaps above a certain loudness or volume). In particular embodiments, wearable computing device 202 can continue to utilize the voice interface while both: (a) gaze 204c is directed at voice activation indicator 210c and (b) speech 206c is being received.

Wearable computing device 202 can use a timer and a threshold amount of time to determine that speech 206c is or is not being received. For example, the timer can expire when no audio input is received at the voice interface for at least the threshold amount of time. In some embodiments, the threshold amount is selected to be long enough to permit short, natural pauses in speech. In other embodiments, a threshold volume can be used as well. e.g., speech input 206c is considered to be received unless audio input falls below the threshold volume for at least the threshold amount of time.

Scenario 200 continues as shown in FIG. 2D with wearer 230 gazing with gaze 204d at the conversational partner. The social cue provided by gaze 204d of looking at the conversational partner can indicate that wearer 230 now is speaking to the conversational partner. By contrasting gaze 204d with gaze 204c, the conversational partner can infer that wearer 230 is done using the voice interface of wearable computing device 202 and that any subsequent speech uttered by wearer 230 is now directed to the conversational partner.

Wearer 230 can then inform the conversational partner that a year has 8,760 hours via uttering speech 206d of FIG. 2D. Upon gazing with gaze 204d away from voice activation indicator 210d, the voice interface of wearable computing device 202 can be deactivated. Also, as shown in FIG. 2D, voice activation indicator 210d can change text and/or color back to the “Voice Off” text shown in FIG. 2A and corresponding color to indicate to wearer 230 that the voice interface of wearable computing device 202 indeed has been deactivated.

Example Head Mountable Devices for Determining Pupil Positions

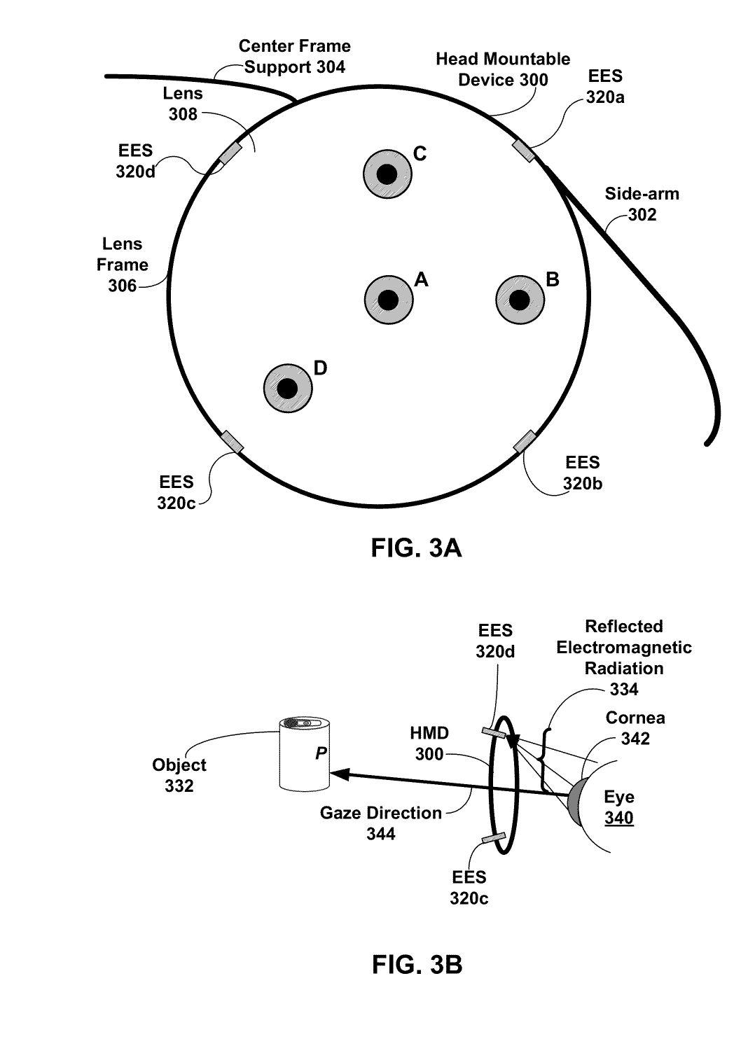

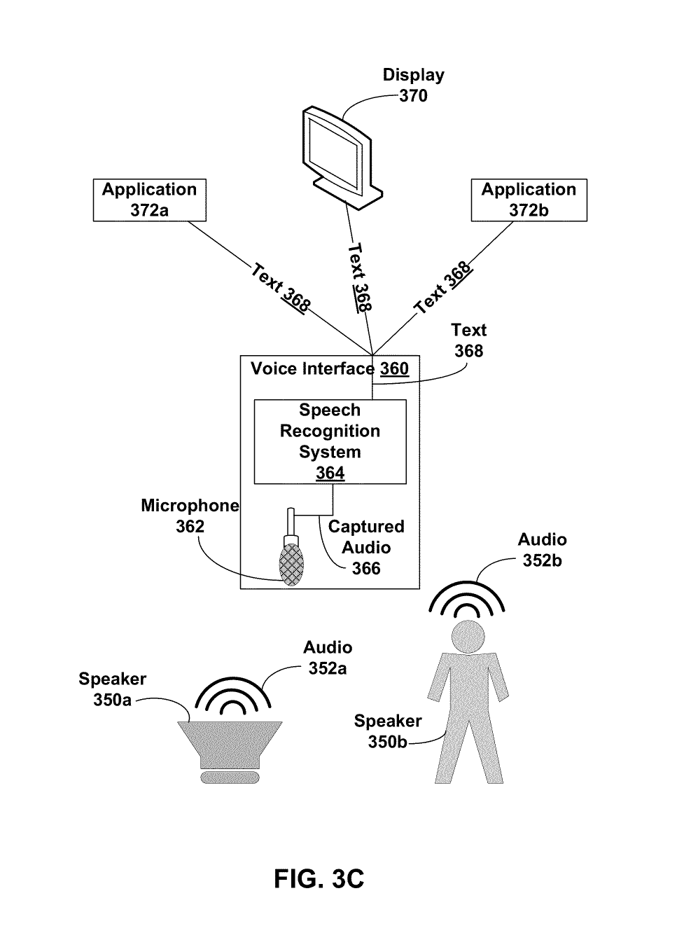

FIG. 3A shows a right side of head mountable device 300 that includes side-arm 302, center-frame support 304, lens frame 306, lens 308, and electromagnetic emitter/sensors (EESs) 320a-320d. The center frame support 304 and extending side-arm 302, along with a left extending side-arm (not shown in FIG. 3A) can be configured to secure head-mounted device 300 to a wearer's face via a wearer's nose and ears, respectively. Lens frame 306 can be configured to hold lens 308 at a substantially uniform distance in front of an eye of the wearer.

Each of electromagnetic emitter/sensors 320a-320d can be configured to emit and/or sense electromagnetic radiation in one or more frequency ranges. In one example, each of electromagnetic emitter/sensors 320a-320d can be configured to emit and sense infrared light. The emitted electromagnetic radiation can be emitted at one or more specific frequencies or frequency ranges, such as an infrared frequency, to both aid detection and to distinguish the emitted radiation from background radiation, such as ambient light.

In some embodiments, the emitted electromagnetic radiation can be emitted using a specific pattern of frequencies or frequency ranges to better distinguish emitted radiation from background radiation and to increase the likelihood of detection of the emitted radiation after reflection from the eye. For example, one or more infrared or ultraviolet frequencies can be used as a specific pattern of frequencies or as part or all of a frequency range. In other embodiments, one or more of electromagnetic emitter/sensors 320a-320d can be implemented using a camera facing toward an eye of a wearer of head mountable device 300.

Electromagnetic emitter/sensors 320a-320d can be configured to emit electromagnetic radiation toward a right eye of a wearer of head mountable device 300 and subsequently detect electromagnetic radiation reflected from the right eye to determine a position of a portion of the right eye. For example, electromagnetic emitter/sensor 320a can be configured to emit and receive electromagnetic radiation at or near the upper-right-hand portion of the right eye and electromagnetic emitter/sensor 320c can be configured to emit and receive electromagnetic radiation at or near the lower-left-hand portion of the right eye of the wearer.

For example, suppose at a time T_{A}, the iris and pupil of the right eye of the wearer were located at position A shown in FIG. 3A; i.e., at the center of lens 308. At time T_{A}, electromagnetic emitter/sensors 320a-320d can emit electromagnetic radiation toward the surface of the right eye, which can reflect some or all of the emitted electromagnetic radiation. Shortly after T_{A}, electromagnetic emitter/sensors 320a-320d can receive the reflected electromagnetic radiation as a “glint” and provide data about the reflected electromagnetic radiation to head mounted display 300 and/or other devices. For example, a sensor of electromagnetic emitter/sensors 320a-320d receives the reflected radiation for a glint, an indication of a position, size, area, and/or other data related to the glint can be generated and provided to head mounted display 300 and/or other devices.

A position of the glint can be determined relative to other glints received by electromagnetic emitter/sensors 320a-320d to determine a relative direction of an iris and/or pupil of an eye. The iris and pupil of a human eye are covered by the cornea, which is a transparent, dome-shaped structure that bulges outward from the rest of the eyeball. The rest of the eyeball is also covered by a white, opaque layer called the sclera. As such, when emitted electromagnetic radiation strikes the eyeball, electromagnetic radiation reflected from the cornea and/or sclera can received at an electromagnetic emitter/sensor.

When electromagnetic radiation reflects from a leading surface of the cornea rather than the sclera (or a trailing surface of the cornea), the electromagnetic radiation can have less distance to travel before being reflected. As such, when the cornea is close to a specific sensor, a corresponding glint appears closer to the sensor as well. Also, when the cornea is farther from a specific sensor, a corresponding glint appears farther from the sensor.

As the sensors in head mountable device 300 are mounted on lens frame 308 near the edges of lens 306, when the cornea is near a closer edge of lens 306, corresponding glints appear closer to the closer edge. Thus, a pair of glints reflecting electromagnetic radiation emitted from sensors mounted on the closer edge appear farther apart than a pair of glints reflecting electromagnetic radiation emitted from sensors mounted on an edge opposite to the closer edge.

Based on the data about the received reflected electromagnetic radiation, a computing device, perhaps associated with head mountable device 300, can determine an estimated position P_{A} of the iris and pupil of the right eye at T_{A} is approximately centered within lens 308. That is, at time T_{A}, electromagnetic emitter/sensors 320a-320d can emit electromagnetic radiation toward the right eye and the emitted light can be reflected from the surface of the right eye as a glint pattern. The resulting glint pattern can have a square or rectangular shape, with distances between each pair of horizontally aligned glints being roughly equal, and distances between each pair of vertically aligned glints being roughly equal.

As another example, suppose at a time T_{B}, the cornea, including iris and pupil of the right eye of the wearer, is located at position B shown in FIG. 3A; i.e., relatively near a right edge of lens 308. A computing device, perhaps associated with head mountable device 300, can determine an estimated position P_{B} of the iris and pupil of the right eye at T_{B} is near the right edge of lens 308.

At time T_{B}, electromagnetic emitter/sensors 320a-320d can emit electromagnetic radiation toward the right eye and the emitted light can be reflected from the surface of the right eye as a glint pattern. The resulting glint pattern can have a trapezoidal shape, with distances between each pair of horizontally aligned glints being roughly equal, and a distance between a pair of vertically aligned glints closest to position B being shorter than a distance between a pair of vertically aligned glints farthest from position B. The computing device can utilize this data to determine that the cornea, and corresponding pupil and iris, is closer to sensors 320a and 320b, and thus closer to a right edge of lens 308.

In some embodiments, each of electromagnetic emitter/sensors 320a-320d can be configured to emit and/or sense electromagnetic radiation in one or more frequency ranges. In one example, each of electromagnetic emitter/sensors 320a-320d can be configured to emit and sense infrared light. The emitted electromagnetic radiation can be emitted at one or more specific frequencies or frequency ranges, such as an infrared frequency, to both aid detection and to distinguish the emitted radiation from background radiation, such as ambient light. In other embodiments, the emitted electromagnetic radiation can be emitted using a specific pattern of frequencies or frequency ranges to better distinguish emitted radiation from background radiation and to increase the likelihood of detection of the emitted radiation after reflection from the eye.

Electromagnetic emitter/sensors 320a-320d can be configured to emit electromagnetic radiation toward an eye of a wearer of head mountable device 300 and subsequently detect reflected electromagnetic radiation to determine a position of a portion of the eye of the wearer.

For example, suppose at a time T_{D} the iris and pupil of the right eye of the wearer were located at position D shown in FIG. 3A. At time T_{D}, electromagnetic emitter/sensors 320a-320d can emit electromagnetic radiation toward the eye of the wearer, where the emitted light can be reflected from the surface of the eye. Shortly after T_{D}, electromagnetic emitter/sensors 320a-320d can receive the reflected electromagnetic radiation.

In this example, suppose the amounts of received light at each of electromagnetic emitter/sensors 320a-320d as shown in Table 2 below:

TABLE 1

| | Amount of Received Light |
|---|---|
| Sensor(s) | (on 1-10 Scale) at T_{D} |
| 320a | 7 |
| 320b | 5 |
| 320c | 1 |
| 320d | 5 |

In other embodiments, one or more of electromagnetic emitter/sensors 320a-320d can provide more or less information about received light to head mountable device 300. As one example, the amount of received light can be expressed using either a single bit, with 0 being dark and 1 being light. As another example, a finer scale than a 1-10 scale can be used; e.g., a 0 (dark) to 255 (bright) scale. Additionally or instead, information about frequencies, direction, and/or other features of received light can be provided by one or more of electromagnetic emitter/sensors 320a-320d. Upon receiving the light, each of sensors 320a-320d can determine the amount of received light, generate an indication of the amount of received light using one or more of the numerical scales, and provide the indication to head mountable device 300.

Based on the information about received reflected electromagnetic radiation, a computing device, perhaps associated with head mountable device 300, can determine an estimated position of the iris and pupil P_{D} of the right eye at T_{D}. As the amount of reflected light received at sensor 320c is considerably smaller than the amounts of light received at sensors 320a, 320b and 320d, head mountable device 300 can determine that there is a relatively-large probability that P_{D} is very near to sensor 320c. Then, considering that the amount of reflected light at sensor 320b is equal to the reflected light at sensor 320d, and the head mountable device 300 can determine that there is a relatively-larger probability that P_{D} is equidistant between sensors 320b and 320d, and, based on the relatively large difference in light values between sensors 320a and 320c, that P_{D} is on or near a line connected sensors 320a and 320c (equidistant from sensors 320b and 320d) and considerably closer to sensor 320c, and thus P_{D} is near the lower-left edge of lens 308 very near to sensor 320c.

Other portions of the eye can be detected as well. For example, suppose each of electromagnetic emitter/sensors 320a-320d receive approximately equal amounts of received electromagnetic radiation, and each amount is relatively high. More light is reflected from a closed eye than from an open eye. Then a computing device, perhaps part of head mountable device 300, can infer the electromagnetic radiation is not being reflected from the eye, but from an eyelid.

In this case, by inferring the electromagnetic radiation is reflected from an eyelid, the computing device can infer that the eye is closed and that the wearer is either blinking (closed the eye for a short time) or has shut their eyes (closed the eye for a longer time).

To determine if the wearer is blinking or has shut their eyes, the computing device can wait a predetermined amount of time, and then request a second set of indications of reflected electromagnetic radiation from the electromagnetic emitter/sensors.

The predetermined amount of time can be based on a blink duration and/or a blink interval. In adult humans, a blink duration, or how long the eye is closed during a blink is approximately 300-400 milliseconds for intentional blinks and approximately 150 milliseconds for a reflex blink (e.g., a blink for spreading tears across the surface of the eye), and a blink rate, or how often the eye is blinked under typical conditions, is between two and ten blinks per minute; i.e., one blink per every six to thirty seconds. Using additional sets of indications of received electromagnetic radiation taken from another eye of the wearer can determine if the wearer has both eyes open, both eyes closed, or has one eye open; e.g., is winking. Also, indications of received electromagnetic radiation taken from another eye can be used to confirm values of received electromagnetic radiation when both eyes can be inferred to be closed.

Other techniques can be used to determine a position of an eye beyond those described herein.

FIG. 3B is a cut-away diagram of eye 340 gazing in gaze direction 344, according to an example embodiment. In FIG. 3B, an eye 340 is viewing an object 332 while head mountable device 300. FIG. 3B shows head mountable device 300 with electromagnetic-radiation emitter/sensor 320d configured to capture electromagnetic radiation e.g., light, reflected from eye 340.

FIG. 3B shows eye 340 gazing in gaze direction 344, shown as an arrow from eye 340 to object 332. Eye 340 includes a cornea 342 that protects an iris, lens, and pupil of eye 340 (iris, lens, and pupil not shown in FIG. 3B). FIG. 3B shows electromagnetic radiation 334, such as ambient light in an environment of eye 340 and/or emitted electromagnetic radiation previously emitted by electromagnetic-radiation emitter/sensor 320d, reflected from eye 340 including cornea 342. Part or all of electromagnetic radiation 334 can be captured by electromagnetic-radiation emitter/sensor to determine gaze direction 344 using the techniques discussed at least in the context of FIG. 3B.

FIG. 3C shows an example voice interface 360 receiving audio inputs 352a, 352b from respective speakers 350a, 350b and generating text 368 as an output, in accordance with an example embodiment. Audio, such as speech, generated by one or more speakers can be received at the voice interface. For example, FIG. 3C shows audio 352a generated by speaker 350a and received at microphone 362, as well as audio 352b generated by speaker 350b and received at microphone 362.

Microphone 362 can capture the received audio and transmit captured audio 366 to speech recognition system 364, which in turn can process captured audio 366 to generate, as an output, a textual interpretation of captured audio 366. The textual interpretation of captured audio 366 is shown in FIG. 3C as text 368, which is provided from voice interface 360 to display 370 and two applications 372a, 372b.

In some embodiments, display 370 is part of voice interface 360 and is perhaps part of a touch screen interface. In other embodiments, more or fewer sources of audio; e.g., speakers 350a and 352a, can be used with voice interface 360. In still other embodiments, more or fewer copies of text 368 can be generated by voice interface 360.

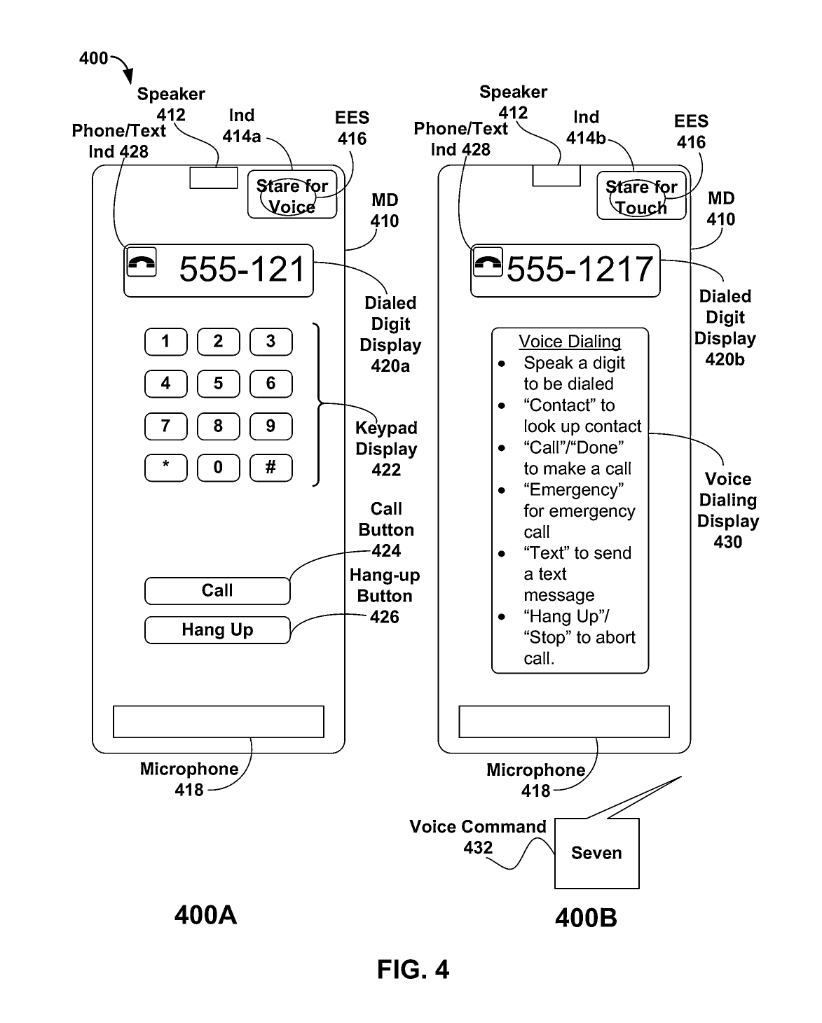

FIG. 4 illustrates an example scenario 400 for switching interfaces for mobile device 410 based on gaze detection, according to an example embodiment. FIG. 4 shows mobile device 410 utilizing a touch interface at 400A of scenario 400. The touch interface includes dialed digit display 420a to show previously-entered digits, keypad display 422 to enter digits, call button 424 to start a communication, hang-up button 426 to end the communication, and phone/text indicator 428 to indicate if a communication is a voice call or text message. Mobile device 410 also includes a speaker 412 to output sounds, and a microphone to capture sounds, such as speech uttered by a user of mobile device 410.

Additionally, at 400A of scenario 400, mobile device 410 includes an indicator 414a with “Stare for Voice” and an electromagnetic radiation emitter/sensor 416. If the user of mobile device gazes at indicator 414a for longer than a threshold period of time (a.k.a. stares at indicator 414a), then mobile device 410 can detect the gaze using electromagnetic-radiation emitter/sensor 416 and switch from utilizing the touch interface shown at 400A to utilizing a voice interface.

In some embodiments, electromagnetic radiation emitter/sensor 416 can include a camera to capture an image of an eye of the user. In other embodiments, electromagnetic radiation emitter/sensor 416 can emit a known frequency of electromagnetic radiation, wait a period of time for the emitted electromagnetic radiation to reflect from the eye to electromagnetic radiation emitter/sensor 416, and determine an eye position based on the reflected radiation received by electromagnetic radiation emitter/sensor 416 at mobile device 410. In still other embodiments, mobile device 410 can compare an eye position received at a first time to an eye position received at a later, second time to determine whether the eye positions at the first and second times indicate a user is staring at indicator 414a. Upon determining that the user is staring at indicator 414a, then mobile device can switch between touch and voice interfaces.

Scenario 400 continues at 400B with mobile device 410 utilizing a voice interface. The voice interface includes microphone 418 to capture sounds, including voice commands such as voice command 432, dialed digit display 420b to show previously-entered digits, phone/text indicator 428 to indicate if a communication is a voice call or text message and voice dialing display 430 to inform a user about voice commands that can be used with the voice interface. Mobile device 410 also includes a speaker 412 to output sounds to a user of mobile device 410.

As shown in FIG. 4, voice dialing display 430 informs a user of mobile device 410 about voice commands that can be used. For example, voice dialing display informs the user that speaking a digit (e.g., “one”, “two” . . . “nine”) will cause the digit to be added as a dialed digit, uttering the word “contact” will initiate a look-up contact procedure, uttering the word “call” or “done” will place a call/complete composition of a text message, saying the word “emergency” will place an emergency call (e.g., a 911 call in the United States), and uttering either the words “Hang up” or “stop” will terminate the communication.

For example, FIG. 4 shows that at 400B, voice command 432 is received at mobile device 410. Voice command 432, which is the word “seven”, is a digit name to be added as a dialed digit. In response to voice command 432, 400B of FIG. 4 shows that the digit “seven” has been added as the last digit of dialed digit display 420b.

In some embodiments, voice dialing display 430 is not provided by mobile device 410 while utilizing the voice interface. In particular, a user of mobile device 410 may be able to select providing or not providing voice dialing display 430. In other embodiments, one or more languages other than English can be used by the voice interface.

Additionally, at 400B of scenario 400, mobile device 410 includes an indicator 414a with “Stare for Touch” and an electromagnetic radiation emitter/sensor 416. A gaze or stare at electromagnetic radiation emitter/sensor 416 can be detected using the techniques discussed above at least in the context of 400A of FIG. 4. Then, upon detecting a gaze/stare at electromagnetic radiation emitter/sensor 416, mobile device 410 can toggle interfaces from using the voice interface shown at 400B of FIG. 4 to using a touch interface as shown at 400A of FIG. 4. In some embodiments, both voice and touch interfaces can be used simultaneously.

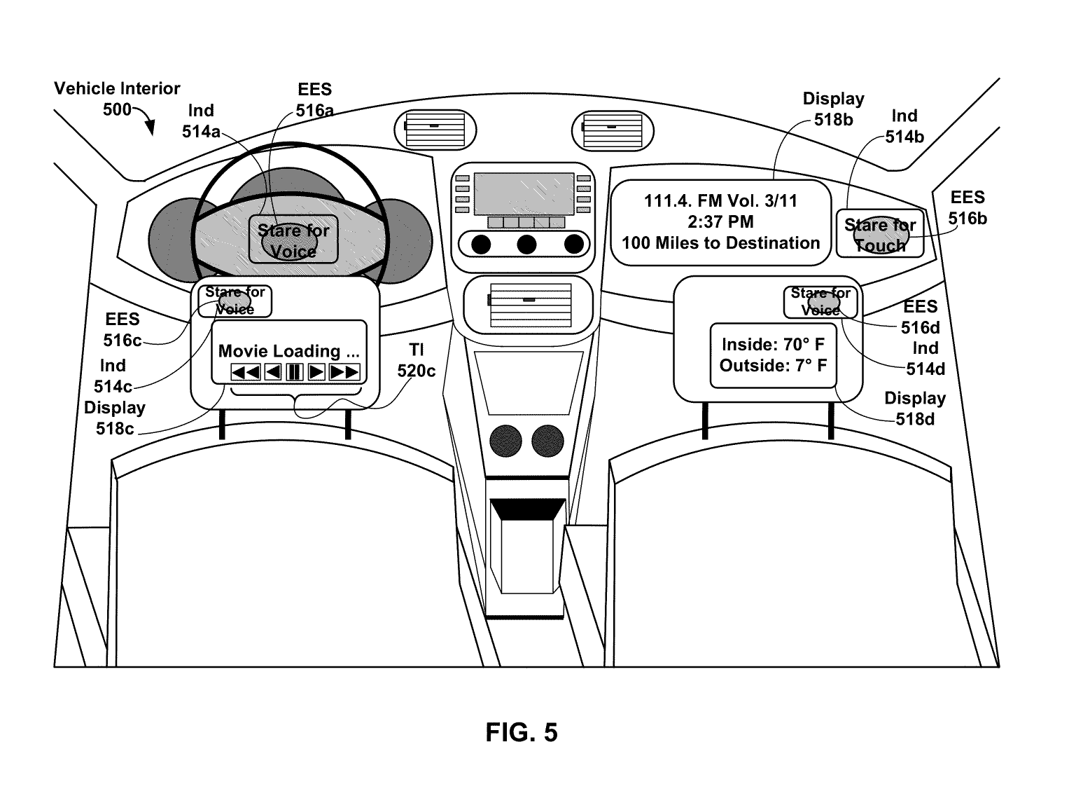

FIG. 5 illustrates an example vehicle interior 500, according to an example embodiment. FIG. 5 shows vehicle interior 500 equipped with a number of indicators 514a-514d and corresponding electromagnetic radiation emitter/sensors 516a-516d. Vehicle interior 500 also includes displays 518b, 518c, and 518d. Each of electromagnetic radiation emitter/sensors 516a-516d can perform the above-disclosed functions of an electromagnetic radiation emitter/sensor. Indicators 514a-514d can provide an indications of respective active interfaces.

By use of electromagnetic radiation emitter/sensors 516a-516d, multiple selections of interfaces can be utilized throughout the vehicle. For example, indicators 516a and 516c indicate that a user is to “stare for voice” to convert an interface from a touch interface to a voice interface, while indicators 516b and 516d indicate that a user is to “stare for touch” to convert an interface from a voice interface to a touch interface. FIG. 5 also shows touch interface (TI) 520c for a movie player with touch buttons for forward (single right-pointing triangle), fast forward (double right-pointing triangles), pause/play (double rectangles), rewind (single left-pointing triangle) and fast rewind (double left-pointing triangles).

Beyond the movie player interface shown in FIG. 5, other interfaces usable within vehicle interior 500 can include voice and/or touch interfaces to control controllable devices, such as a cruise control, radio, air conditioner, locks/doors, heater, headlights, and/or other devices. In some embodiments, a hierarchy of interfaces can be used; e.g., a command from a driver can inhibit or permit use of voice interfaces in the rear seat and/or by a front-seat passenger. Also, different interfaces can permit control over different devices within vehicle interior 500; e.g., a voice and/or voice interface associated with the driver can control all controllable devices, while a voice and/or voice interface associated with a rear-seat passenger can control a movie player and temperature controls associated with their seat. Many other examples are possible as well.

Example Systems and Devices

Systems and devices in which example embodiments may be implemented will now be described in greater detail. In general, an example system may be implemented in or may take the form of a wearable computer. However, an example system may also be implemented in or take the form of other devices, such as a mobile phone, among others. Further, an example system may take the form of non-transitory computer readable medium, which has program instructions stored thereon that are executable by at a processor to provide the functionality described herein. An example, system may also take the form of a device such as a wearable computer or mobile phone, or a subsystem of such a device, which includes such a non-transitory computer readable medium having such program instructions stored thereon.

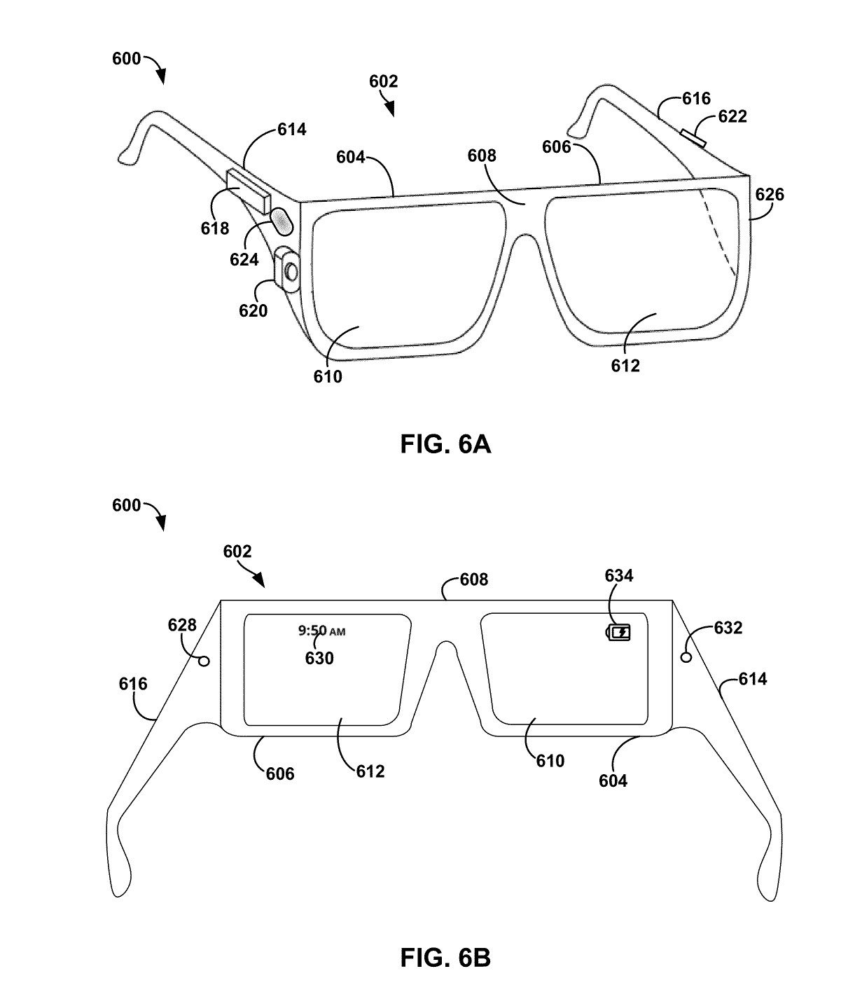

FIGS. 6A and 6B illustrate a wearable computing device 600, according to an example embodiment. In FIG. 6A, the wearable computing device 600 takes the form of a head-mountable device (HMD) 602. It should be understood, however, that example systems and devices may take the form of or be implemented within or in association with other types of devices, without departing from the scope of the invention.

As illustrated in FIG. 6A, the head-mountable device 602 comprises frame elements including lens-frames 604 and 606 and a center frame support 608, lens elements 610 and 612, and extending side-arms 614 and 616. The center frame support 608 and the extending side-arms 614 and 616 are configured to secure the head-mountable device 602 to a wearer's face via a wearer's nose and ears, respectively.

Each of the frame elements 604, 606, and 608 and the extending side-arms 614 and 616 may be formed of a solid structure of plastic or metal, or may be formed of a hollow structure of similar material so as to allow wiring and component interconnects to be internally routed through the head-mountable device 602. Other materials may possibly be used as well.

One or both of lens elements 610 and 612 may be formed of any material that can suitably display a projected image or graphic. One or both of lens elements 610 and 612 may also be sufficiently transparent to allow a wearer to see through the lens element. Combining these two features of lens elements 610, 612 can facilitate an augmented reality or heads-up display where the projected image or graphic is superimposed over a real-world view as perceived by the wearer through the lens elements.

The extending side-arms 614 and 616 each may be projections that extend away from the frame elements 604 and 606, respectively, and are positioned behind a wearer's ears to secure the head-mountable device 602. The extending side-arms 614 and 616 may further secure the head-mountable device 602 to the wearer by extending around a rear portion of the wearer's head. Additionally or alternatively, for example, head-mountable device 602 may connect to or be affixed within a head-mounted helmet structure. Other possibilities exist as well.

Head-mountable device 602 may also include an on-board computing system 618, video camera 620, sensor 622, and finger-operable touchpads 624, 626. The on-board computing system 618 is shown on the extending side-arm 614 of the head-mountable device 602; however, the on-board computing system 618 may be positioned on other parts of the head-mountable device 602 or may be remote from head-mountable device 602; e.g., the on-board computing system 618 could be wired to or wirelessly-connected to the head-mounted device 602.

The on-board computing system 618 may include a processor and memory, for example. The on-board computing system 618 may be configured to receive and analyze data from video camera 620, sensor 622, and the finger-operable touchpads 624, 626 (and possibly from other sensory devices, user interfaces, or both) and generate images for output from the lens elements 610 and 612 and/or other devices.

The sensor 622 is shown mounted on the extending side-arm 616 of the head-mountable device 602; however, the sensor 622 may be provided on other parts of the head-mountable device 602. The sensor 622 may include one or more of a gyroscope or an accelerometer, for example. Other sensing devices may be included within the sensor 622 or other sensing functions may be performed by the sensor 622.

In an example embodiment, sensors such as sensor 622 may be configured to detect head movement by a wearer of head-mountable device 602. For instance, a gyroscope and/or accelerometer may be arranged to detect head movements, and may be configured to output head-movement data. This head-movement data may then be used to carry out functions of an example method, such as method 100, for instance.

The finger-operable touchpads 624, 626 are shown mounted on the extending side-arms 614, 616 of the head-mountable device 602. Each of finger-operable touchpads 624, 626 may be used by a wearer to input commands. The finger-operable touchpads 624, 626 may sense at least one of a position and a movement of a finger via capacitive sensing, resistance sensing, or a surface acoustic wave process, among other possibilities. The finger-operable touchpads 624, 626 may be capable of sensing finger movement in a direction parallel or planar to the pad surface, in a direction normal to the pad surface, or both, and may also be capable of sensing a level of pressure applied. The finger-operable touchpads 624, 626 may be formed of one or more transparent or transparent insulating layers and one or more transparent or transparent conducting layers. Edges of the finger-operable touchpads 624, 626 may be formed to have a raised, indented, or roughened surface, so as to provide tactile feedback to a wearer when the wearer's finger reaches the edge of the finger-operable touchpads 624, 626. Each of the finger-operable touchpads 624, 626 may be operated independently, and may provide a different function.

FIG. 6B illustrates an alternate view of the wearable computing device shown in FIG. 6A. As shown in FIG. 6B, the lens elements 610 and 612 may act as display elements. The head-mountable device 602 may include a first projector 628 coupled to an inside surface of the extending side-arm 616 and configured to project a display 630 onto an inside surface of the lens element 612. Additionally or alternatively, a second projector 632 may be coupled to an inside surface of the extending side-arm 614 and configured to project a display 634 onto an inside surface of the lens element 610.

The lens elements 610 and 612 may act as a combiner in a light projection system and may include a coating that reflects the light projected onto them from the projectors 628 and 632. In some embodiments, a special coating may not be used (e.g., when the projectors 628 and 632 are scanning laser devices).

In alternative embodiments, other types of display elements may also be used. For example, the lens elements 610, 612 themselves may include: a transparent or semi-transparent matrix display, such as an electroluminescent display or a liquid crystal display, one or more waveguides for delivering an image to the wearer, or other optical elements capable of delivering an in focus near-to-eye image to the wearer. A corresponding display driver may be disposed within the frame elements 604 and 606 for driving such a matrix display. Alternatively or additionally, a laser or light-emitting diode (LED) source and scanning system could be used to draw a raster display directly onto the retina of one or more of the wearer's eyes. Other possibilities exist as well.

While FIGS. 6A and 6B show two touchpads and two display elements, it should be understood that many example methods and systems may be implemented in wearable computing devices with only one touchpad and/or with only one lens element having a display element. It is also possible that example methods and systems may be implemented in wearable computing devices with more than two touchpads.

The outward-facing video camera 620 is shown to be positioned on the extending side-arm 614 of the head-mountable device 602; however, the outward-facing video camera 620 may be provided on other parts of the head-mountable device 602. The outward-facing video camera 620 may be configured to capture images at various resolutions or at different frame rates. Many video cameras with a small form-factor, such as those used in cell phones or webcams, for example, may be incorporated into an example of wearable computing device 600.

Although FIG. 6A illustrates one outward-facing video camera 620, more outward-facing video cameras may be used than shown in FIG. 6A, and each outward-facing video camera may be configured to capture the same view, or to capture different views. For example, the outward-facing video camera 620 may be forward facing to capture at least a portion of the real-world view perceived by the wearer. This forward facing image captured by the outward-facing video camera 620 may then be used to generate an augmented reality where computer generated images appear to interact with the real-world view perceived by the wearer.

In some embodiments not shown in FIGS. 6A and 6B, wearable computing device 600 can also or instead include one or more inward-facing cameras. Each inward-facing camera can be configured to capture still images and/or video of part or all of the wearer's face. For example, the inward-facing camera can be configured to capture images of an eye of the wearer. Wearable computing device 600 may use other types of sensors to detect a wearer's eye movements, in addition to or in the alternative to an inward-facing camera. For example, wearable computing device 600 could incorporate a proximity sensor or sensors, which may be used to measure distance using infrared reflectance. In one such embodiment, lens element 610 and/or 612 could include a number of LEDs which are each co-located with an infrared receiver, to detect when a wearer looks at a particular LED. As such, eye movements between LED locations may be detected. Other examples are also possible.

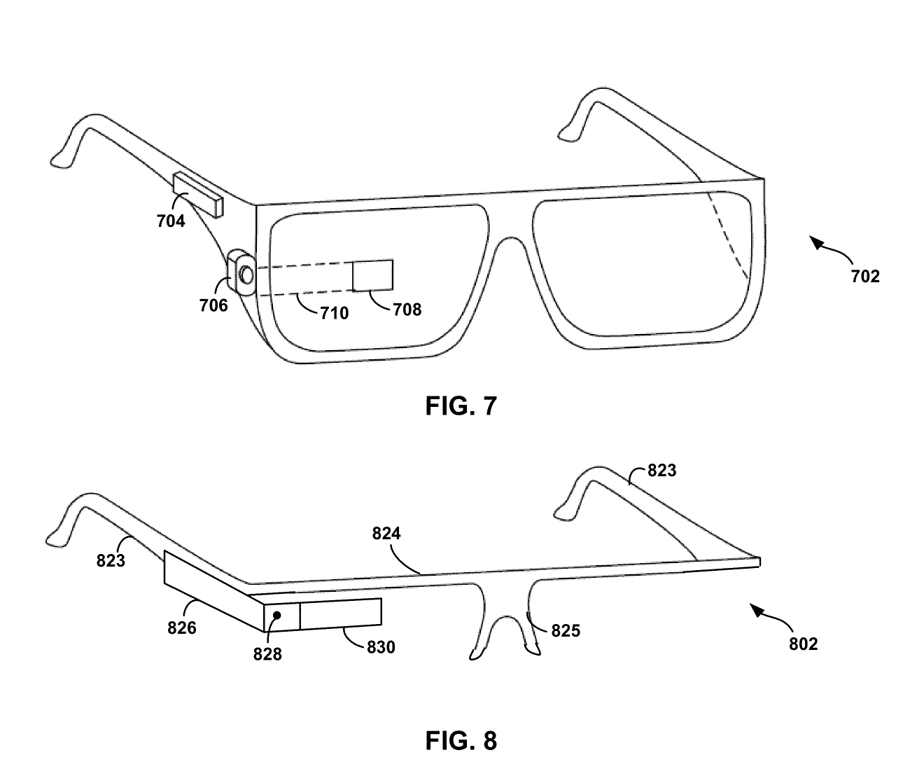

FIG. 7 illustrates another wearable computing device, according to an example embodiment, which takes the form of head-mountable device 702. Head-mountable device 702 may include frame elements and side-arms, such as those described with respect to FIGS. 6A and 6B. Head-mountable device 702 may additionally include an on-board computing system 704 and video camera 706, such as described with respect to FIGS. 6A and 6B. Video camera 706 is shown mounted on a frame of head-mountable device 702. However, video camera 706 may be mounted at other positions as well.

As shown in FIG. 7, head-mountable device 702 may include display 708 which may be coupled to a wearable computing device. Display 708 may be formed on one of the lens elements of head-mountable device 702, such as a lens element described with respect to FIGS. 6A and 6B, and may be configured to overlay computer-generated graphics on the wearer's view of the physical world.

Display 708 is shown to be provided in a center of a lens of head-mountable device 702; however, the display 708 may be provided in other positions. The display 708 can be controlled using on-board computing system 704 coupled to display 708 via an optical waveguide 710.

FIG. 8 illustrates yet another wearable computing device, according to an example embodiment, which takes the form of head-mountable device 802. Head-mountable device 802 can include side-arms 823, a center frame support 824, and a bridge portion with nosepiece 825. In the example shown in FIG. 8, the center frame support 824 connects the side-arms 823. As shown in FIG. 8, head-mountable device 802 does not include lens-frames containing lens elements. Head-mountable device 802 may additionally include an on-board computing system 826 and video camera 828, such as described with respect to FIGS. 6A and 6B.

Head-mountable device 802 may include a single lens element 830 configured to be coupled to one of the side-arms 823 and/or center frame support 824. The lens element 830 may include a display such as the display described with reference to FIGS. 5A and 5B, and may be configured to overlay computer-generated graphics upon the wearer's view of the physical world. In one example, the single lens element 830 may be coupled to the inner side (i.e., the side exposed to a portion of a wearer's head when worn by the wearer) of the extending side-arm 823. The single lens element 830 may be positioned in front of or proximate to a wearer's eye when head-mountable device 802 is worn. For example, the single lens element 830 may be positioned below the center frame support 824, as shown in FIG. 8.

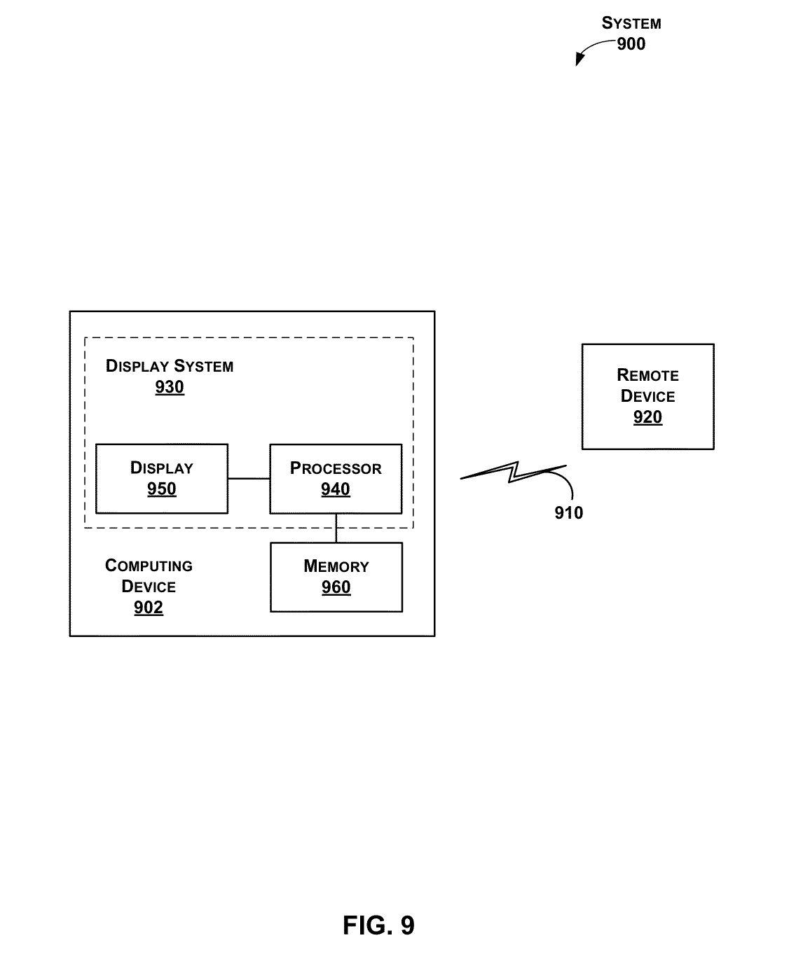

FIG. 9 illustrates a schematic drawing of a computing system 900 according to an example embodiment. In system 900, a computing device 902 communicates using a communication link 910 (e.g., a wired or wireless connection) to a remote device 920. Computing device 902 may be any type of device that can receive data and display information corresponding to or associated with the data. For example, the device 902 may be associated with and/or be part or all of a heads-up display system, such as the wearable computing device 202, head mountable devices 300, 602, 702, 802, mobile device 410, and/or vehicle interior 500, described with reference to FIGS. 2A-8.

Thus, computing device 902 may include display system 930, processor 940, and display 950. Display 950 may be, for example, an optical see-through display, an optical see-around display, or a video see-through display. Processor 940 may receive data from remote device 920 and configure the data for display on display 950. Processor 940 may be any type of processor, such as a micro-processor or a digital signal processor, for example.

Computing device 902 may further include on-board data storage, such as memory 960 coupled to the processor 940. Memory 960 may store software that can be accessed and executed by the processor 940. For example, memory 960 may store software that, if executed by processor 940 is configured to perform some or all of the functionality described herein, for example.

Remote device 920 may be any type of computing device or transmitter including a laptop computer, a mobile telephone, or tablet computing device, etc., that is configured to transmit and/or receive data to/from computing device 902. Remote device 920 and computing device 902 may contain hardware to establish, maintain, and tear down communication link 910, such as processors, transmitters, receivers, antennas, etc.

In FIG. 9, communication link 910 is illustrated as a wireless connection; however, communication link 910 can also or instead include wired connection(s). For example, the communication link 910 may include a wired serial bus such as a universal serial bus or a parallel bus. A wired connection may be a proprietary connection as well. The communication link 910 may also include a wireless connection using, e.g., Bluetooth® radio technology, communication protocols described in IEEE 802.11 (including any IEEE 802.11 revisions), cellular technology (such as GSM, CDMA, UMTS, EV-DO, WiMAX, or LTE), or Zigbee® technology, among other possibilities. Computing device 902 and/or remote device 920 may be accessible via the Internet and may include a computing cluster associated with a particular web service (e.g., social-networking, photo sharing, address book, etc.).

### CONCLUSION

Example methods and systems are described herein. The example embodiments described herein are not meant to be limiting. It will be readily understood that certain aspects of the disclosed systems and methods can be arranged and combined in a wide variety of different configurations, all of which are contemplated herein.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method, comprising:
displaying, on a see-through display of a head-mountable device, a graphical interface;
defining, using the head-mountable device, a range of social gaze that provide a social cue indicating interaction with the head-mountable device, wherein the range of social gaze directions corresponds to voice-control activation;
determining a gaze direction using an electromagnetic emitter/sensor (EES) configured to emit infrared radiation, detect the infrared radiation after reflection, and communicate reflection data about detected reflected infrared radiation to the head-mountable device;
determining, using the head-mountable device, that the gaze direction is within the range of social gaze directions based on the reflection data, wherein determining that the gaze direction is within the range of social gaze directions based on the reflection data does not comprise mapping gaze direction to coordinates on the see-through display; and
in response to the head-mountable device determining that the gaze direction is within the range of social gaze directions, (i) the head-mountable device activating a voice interface of the head-mountable device and (ii) displaying, on the graphical interface, a voice activation indicator at a location of the see-through display that is within the range of social gaze directions, wherein the voice activation indicator is configured to indicate that the voice interface is activated.

2. The method of claim 1, wherein the range of social gaze directions is divided into a plurality of ranges of social gaze directions.

3. The method of claim 1, further comprising:
in response to determining that a later gaze direction is not within the range of social gaze directions, deactivating the voice interface.

4. The method of claim 1, further comprising:
after activating the voice interface, receiving speech input via the activated voice interface of the computing device;
generating a textual interpretation of at least part of the speech input; and
providing a command to an application based on the generated textual interpretation.

5. The method of claim 1, further comprising:
determining whether the gaze direction remains within the range of social gaze directions; and
in response to determining that the gaze direction does not remain within the range of social gaze directions, deactivating the voice interface.

6. The method of claim 1, wherein the range of social gaze directions comprises a range of gaze directions from an eye toward the voice activation indicator.

7. The method of claim 6, wherein determining that the gaze direction is within the range of social gaze directions comprises determining that the eye is directed toward the voice activation indicator for a period of time exceeding a threshold amount of time.

8. The method of claim 1, wherein the voice activation indicator is configured to indicate an activation status of the voice interface that corresponds to the activation of the voice interface, and
wherein the method further comprises:
determining whether or not the gaze direction remains within the range of social gaze directions;
in response to determining that the gaze direction does not remain within the range of social gaze directions, maintaining the activation status of the voice interface;
after maintaining the activation status of the voice interface, determining whether a later gaze direction is within the range of social gaze directions; and
in response to determining that the later gaze direction is within the range of social gaze directions, toggling the activation status of the voice interface.

9-11. (canceled)

12. The method of claim 1, further comprising:
receiving a secondary signal at the head-mountable device; and
wherein activating the voice interface of the head-mountable device comprises activating the voice interface of the head-mountable device in response to both: (i) determining that the gaze direction is within the range of social gaze directions and (ii) receipt of the secondary signal.

13. A head-mountable device, comprising:
a see-through display;
a processor;
a voice interface;
an electromagnetic emitter/sensor (EES), configured to:
emit infrared radiation,
detect the infrared radiation after reflection, and
communicate reflection data about detected reflected infrared radiation;
a non-transitory computer-readable medium; and
program instructions stored on the non-transitory computer-readable medium, that are executable by the processor to cause the computing device to perform functions comprising:
displaying, on the see-through display, a graphical interface;
defining a range of social gaze directions that provide a social cue indicating interaction with the head-mountable device, wherein the range of social gaze directions corresponds to voice-control activation;
determining a gaze direction using the EES;
determining that the gaze direction is within the range of social gaze directions based on the reflection data, wherein determining that the gaze direction is within the range of social gaze directions based on the reflection data does not comprise mapping gaze direction to coordinates on the see-through display; and
in response to determining that the gaze direction is within the range of social gaze directions, (i) activating the voice interface and (ii) displaying, on the graphical interface, a voice activation indicator at a location of the see-through display that is within the range of social gaze directions, wherein the voice activation indicator is configured to indicate that the voice interface is activated.

14. The computing device of claim 13, wherein the range of social gaze directions is divided into a plurality of ranges of social gaze directions.

15. The computing device of claim 13, wherein the functions further comprise:
in response to determining that a later gaze direction is not within the range of social gaze directions, deactivating the voice interface.

16. The computing device of claim 13, wherein the functions further comprise:
after activating the voice interface, receiving speech input via the activated voice interface;
generating a textual interpretation of at least part of the speech input; and
providing a command to an application based on the generated textual interpretation.

17. The computing device of claim 13, wherein the range of social gaze directions comprises a range of gaze-directions from an eye toward the voice activation indicator.

18. An article of manufacture including a non-transitory computer-readable medium having instructions stored thereon that, when executed by a computing device, cause the computing device to perform functions comprising:
displaying, on a see-through display of a head-mountable device, a graphical interface;
defining a range of social gaze directions that provide a social cue indicating interaction with the head-mountable device, wherein the range of social gaze directions corresponds to voice-control activation;
determining a gaze direction using reflection data from an electromagnetic emitter/sensor (EES) configured to emit infrared radiation, detect the infrared radiation after reflection, and communicate the reflection data about detected reflected infrared radiation;
determining that the gaze direction is within the range of social gaze directions based on the reflection data, wherein determining that the gaze direction is within the range of social gaze directions based on the reflection data does not comprise mapping gaze direction to coordinates on the see-through display; and
in response to determining that the gaze direction is within the range of social gaze directions, (i) activating a voice interface and (ii) displaying a voice activation indicator at a location of the see-through display that is within the range of social gaze directions, wherein the voice activation indicator is configured to indicate that the voice interface is activated.

19. The article of manufacture of claim 18, wherein the range of social gaze directions is divided into a plurality of ranges of social gaze directions.

20. The article of manufacture of claim 18, wherein the functions further comprise:
in response to determining that a later gaze direction is not within the range of social gaze directions, deactivating the voice interface.

21. The article of manufacture of claim 18, wherein the functions further comprise:
after activating the voice interface, receiving speech input via the activated voice interface;
generating a textual interpretation of at least part of the speech input; and
providing a command to an application based on the generated textual interpretation.

22. The method of claim 1, wherein the range of social gaze directions comprises (i) a range of directions positioned upward from a straight-ahead line of sight and (ii) a range of directions positioned downward from the straight-ahead line of sight.
